(19) United States
(12) Patent Application Publication
(10) Pub. No.: US 2026/0225537 A1
(43) Pub. Date: Aug. 6, 2026

(54) MOUNTING SYSTEM FOR DEVICES OR OBJECTS IN A VEHICLE AND METHODS OF MAKING AND USING

(71) Applicant: National Products, Inc., Seattle, WA (US)

(72) Inventors: Jeffrey D. Carnevali, Seattle, WA (US); Stefan Michael Gottschalk, Seattle, WA (US)

(21) Appl. No.: 19/043,280

(22) Filed: Jan. 31, 2025

(51) Int. Cl. B60R 11/02; B60R 11/00

(52) U.S. Cl. CPC B60R 11/0229; B60R 11/0252; B60R 2011/0005; B60R 2011/0007; B60R 2011/0038; B60R 2011/005; B60R 2011/0085

(57) ABSTRACT

A mounting system for mounting devices or objects within a vehicle includes a rail having a first end and a second end for coupling to the floor of the vehicle, the rail includes a first section extending upward from the first end, a second section extending upward from the second end, and a horizontal section intermediate between the first section to the second section. The rail is configured for attachment of one or more mounts to the rail at multiple positions along the rail. The mounting system also includes a first attachment arrangement for attachment of the first end of the rail to the floor of the vehicle; a second attachment arrangement for attachment of the second end of the rail to the floor of the vehicle; and, optionally, an intermediate attachment arrangement for coupling the horizontal section to a dashboard, console, or engine cover of the vehicle.

### FIELD

The present invention is directed to mounting systems for devices or objects in a vehicle. The present invention is also directed to mounting systems for devices or objects in a vehicle that are attached to the floor and dashboard or other portion of the vehicle.

### BACKGROUND

Mobile devices, such as smartphones, cellular or mobile phones, tablets, personal data assistants, and other portable devices, are now ubiquitous. Mounts and cradles can be used to protect the mobile device, to mount the mobile device onto a surface or object, or to provide power, or data to or from, the mobile device, or any combination thereof. It is often desirable to mount a mobile device or other objects within a vehicle. There is a need for a system for mounting devices and objects in a vehicle.

### BRIEF SUMMARY

One embodiment is a mounting system for mounting devices or objects within a vehicle. The mounting system includes a rail having a first end configured for coupling to a floor of the vehicle and a second end, opposite the first end, configured for coupling to the floor of the vehicle, the rail including a first section extending upward from the first end away from the floor of the vehicle when the rail is coupled to the floor of the vehicle, a second section extending upward from the second end away from the floor of the vehicle when the rail is coupled to the floor of the vehicle, and a horizontal section intermediate between the first section to the second section and having a horizontal length of at least 0.07 meters, wherein the rail is configured for attachment of one or more mounts to the rail at multiple positions along the rail; a first attachment arrangement configured for attachment to the first end of the rail and for attachment to the floor of the vehicle; a second attachment arrangement physically separate from the first attachment arrangement and configured for attachment to the second end of the rail and for attachment to the floor of the vehicle; and an intermediate attachment arrangement configured for coupling the horizontal section of the rail to a dashboard, console, or engine cover of the vehicle.

A further embodiment is a mounting system for mounting devices or objects within a vehicle. The mounting system includes a rail having a first end configured for coupling to a floor of the vehicle and a second end, opposite the first end, configured for coupling to the floor of the vehicle, the rail including a first section extending upward from the first end away from the floor of the vehicle when the rail is coupled to the floor of the vehicle, a second section extending upward from the second end away from the floor of the vehicle when the rail is coupled to the floor of the vehicle, and a horizontal section intermediate between the first section to the second section and having a horizontal length of at least 0.07 meters, wherein the rail is configured for attachment of one or more mounts to the rail at multiple positions along the rail; a first attachment arrangement configured for attachment to the first end of the rail and for attachment to the floor of the vehicle; and a second attachment arrangement physically separate from the first attachment arrangement and configured for attachment to the second end of the rail and for attachment to the floor of the vehicle.

In at least some embodiments, the horizontal section has a horizontal length of at least 0.1 meters. In at least some embodiments, the rail includes at least one additional upward-extending section. In at least some embodiments, the rail includes at least one additional horizontal section. In at least some embodiments, the rail includes at least six bends.

In at least some embodiments, the rail includes tubing. In at least some embodiments, the rail is made of a plastic material. In at least some embodiments, the rail is made of metal. In at least some embodiments, each of the first attachment arrangement and the second attachment arrangement includes a bracket. In at least some embodiments, each of the first attachment arrangement and the second attachment arrangement is configured for coupling to a floor track of the vehicle using a fastener of the floor track.

In at least some embodiments, the mounting system further includes a mount attached or attachable to the rail. In at least some embodiments, the mount is configured for coupling to a device or object. In at least some embodiments, the mount is configured for at least one of rotating, tilting, pivoting, or swiveling the coupled device or object.

Another embodiment is a method for using any of the mounting systems described above. The method includes providing the mounting system in the vehicle; and attaching a mount to the rail of the mounting system.

In at least some embodiments, the method further includes attaching a device or object to the mount. In at least some embodiments, the method further includes pivoting, rotating, tilting, or swiveling the device or object attached to the mount.

In at least some embodiments, providing the mounting system includes attaching the first attachment arrangement, the second attachment arrangement, and, when used, the intermediate attachment arrangement to the vehicle. In at least some embodiments, the attaching includes attaching each of the first attachment arrangement and the second attachment arrangement to a different floor track or seat bolt of the vehicle using a fastener of the floor track. In at least some embodiments, the attaching including attaching the intermediate attachment arrangement to the rail and to a dashboard, console, or engine cover of the vehicle.

Yet another embodiment is a method for making any of the mounting arrangement the mounting systems describe above. The method includes providing tubing; and bending the tubing to form the rail with a plurality of bends. In at least some embodiments, the method further includes scanning the vehicle or another vehicle of a same type with a three-dimensional scanner to obtain a shape of components within the vehicle, wherein the bending includes bending the tubing using the scan of the vehicle to produce a shape of the rail.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a schematic perspective side view of one embodiment of a mounting system for a mounting devices or objects in a vehicle, according to the invention;

FIG. 2 is a schematic perspective side view of the mounting system of FIG. 1 with attached devices and objects, according to the invention;

FIG. 3 is a schematic perspective side view of the mounting system of FIG. 1 with attached devices and objects after swiveling or rotation, according to the invention;

FIG. 4 is a schematic perspective side view of the mounting system of FIG. 1 installed in a vehicle, according to the invention;

FIG. 5A is a schematic perspective side view of a portion of the mounting system of FIG. 1A for attachment to the floor of the vehicle, according to the invention;

FIG. 5B is a schematic perspective side view of a portion of the mounting system of FIG. 1A attached, according to one embodiment, to the floor of the vehicle, according to the invention;

FIG. 6A is a schematic perspective side view of a portion of the mounting system of FIG. 1A for attachment to the dashboard (or console or engine cover) of the vehicle, according to the invention; and

FIG. 6B is a schematic perspective side view of a portion of the mounting system of FIG. 1A attached, according to one embodiment, to the dashboard (or console or engine cover) of the vehicle, according to the invention.

### DETAILED DESCRIPTION

The present invention is directed to mounting systems for devices or objects in a vehicle. The present invention is also directed to mounting systems for devices or objects in a vehicle that are attached to the floor and dashboard or other portion of the vehicle.

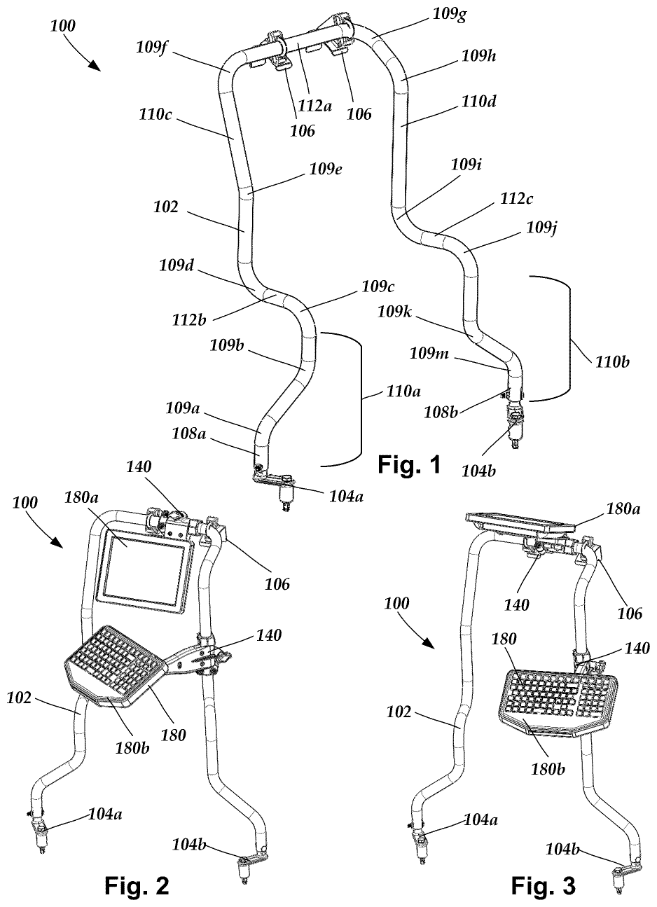

FIGS. 1 to 4 illustrate one embodiment of a mounting system 100 for mounting devices (e.g., mobile devices) or other objects 180 within a vehicle 150. Non-limiting examples of devices or objects 180 that may be mountable on the mounting system 100 can include, but are not limited to, laptop computers, tablets, mobile phones, keyboards, charging or data transfer docks or cradles for electronic devices, monitors, mouse trays, printers, cameras, point-of-sale devices, global positioning system (GPS) devices, radios, weapon holders, mirrors, lights, beverage cup holders, antennas, light bar controls, siren controls, or any other suitable device (e.g., suitable electronic devices) or object. Non-limiting examples of docks or cradles are described in U.S. Pat. Nos. 9,831,904; 11,029,731; 11,076,032; 11,277,506; 11,289,864; 11,489,350; and 12,126,199; U.S. Patent Application Publication No. 2024/0361803; and U.S. Patent Applications Ser. No. 18/590,837 and Ser. No. 18/621,977, all of which are incorporated herein by reference in their entireties. In at least some embodiments, the mounting system can facilitate the mounting of multiple devices and objects. In at least some embodiments, the mounting system can be readily attached within the vehicle without substantial vehicle modification. In at least some embodiments, the mounting system can provide ample mounting space while limiting interference with existing vehicle structures and controls.

The mounting system 100 includes a rail 102, a first attachment arrangement 104a, a second attachment arrangement 104b, and at least one intermediate attachment arrangement 106. In at least some embodiments, the mounting system does not include the at least one intermediate attachment arrangement 106. The rail 102 is arranged for the attachment of one or more mounts 140 to the rail for mounting the device(s) or object(s) 180 to the rail. In at least some embodiments, the rail 102, or a part of the rail 102, is formed using tubing or other hollow, elongate object, although elongate solid (e.g., non-hollow) objects can also be used for the rail or portions of the rail. The rail 102 can be made from any suitable material including, but not limited to, plastic material (for example, polyvinyl chloride (PVC), nylon, polyethylene, polypropylene, or polyurethane or the like or any combination thereof), fiberglass, metal (for example, aluminum, copper, stainless steel, or steel, or the like or any combination thereof), or the like or any combination thereof. The rail 102, or a part of the rail 102, can have a circular, oval, rectangular, square, triangular, octagonal, hexagonal, or any other suitable cross-sectional shape. The rail 102 can have any suitable outer diameter or cross-sectional width(s) and can have any suitable tubing thickness. The materials, cross-sectional shape, outer diameter, cross-sectional width, tubing thickness, or other structural features of the rail 102 can be uniform along the entire rail or can differ along the rail.

The rail 102 has multiple bends, such as bends 109a, 109b, 109c, 109d, 109e, 109f, 109g, 109h, 109i, 109j, 109k, 109m of the rail 102 illustrated in FIG. 1. In at least some embodiments, the rail can be shaped using a CNC (computer numerical control) tube bender or the like or any other suitable machinery or method. The rail 102 can be formed as a single part or formed as multiple parts that are joined together using adhesive, fasteners, or any other suitable joining element(s) or method. For example, the rail 102 can be formed using a single tube or multiple tube sections that are joined together.

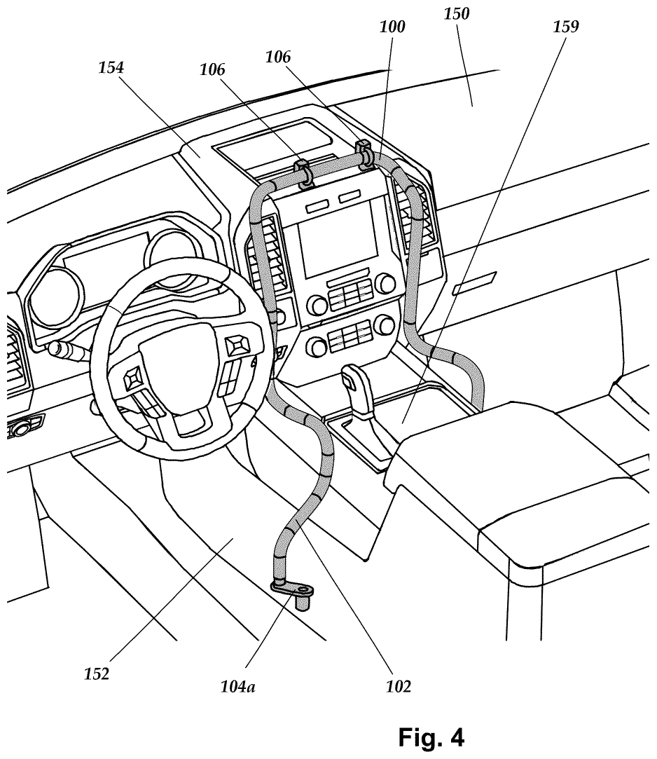

In at least some embodiments, the overall shape, including the bends and straight sections, of the rail 102 is designed in view of the contours of the vehicle, for example, the contours of one or more of the dashboard, console, engine cover, or the like or any combination thereof, as illustrated, for example, in FIG. 4. In at least some embodiments, the surfaces of the vehicle (for example, the dashboard, console, floor, engine cover, or other portions of the vehicle (or any combination thereof) near the site for placement of the rail 102) can be scanned in three dimensions and the rail 102 can be designed to fit the scanned contours, surfaces, or shapes of the vehicle or its components. For example, the shape of the rail 102 can be designed using a software program or application (e.g., a computer-aided design (cad) program or application) manually, automatically by a computer, or any combination thereof and the resulting geometry of the rail can be delivered to a machine (e.g., a CNC tube bender) to form tubing or other materials into the rail. In at least some embodiments, the rail 102 can be custom designed for a particular vehicle. In at least some embodiments, a rail 102 can be designed for a particular make or model of a vehicle or for a range of makes or models.

In at least some embodiments, the rail 102 includes first and second sections 110a, 110b extending upward (for example, extending vertically, non-horizontally, or at an angle, relative to the floor of the vehicle where the rail is attached, in a range of 30 to 90 degrees) from the first and second ends 108a, 108b, respectively, of the rail when the rail is coupled to the floor 152 of the vehicle 150. In at least some embodiments, a section “extends upward” or is “upward-extending” when portions of the section further from the end of the rail 102 closest to that section are also further in distance from the floor of the vehicle when the rail 102 is attached to the floor of the vehicle. (In at least some embodiments, one or both of the first or second ends 108a, 108b may include a horizontal (e.g., lateral) portion from which the first or second section 110a, 110b, respectively, extends.) In at least some embodiments, the rail 102 includes one or more additional upward-extending sections (e.g., sections 110c, 110d, as illustrated in FIG. 1). In at least some embodiments, one or more of the first section 110a, second section 110b, or any additional upward-extending section can include one or more bends. As an example, the first section 110a of the embodiment of the rail 102 illustrated in FIG. 1 includes bends 109a, 109b.

The rail 102 also includes a horizontal section 112a, which, in at least some embodiments, facilitates coupling the rail to a dashboard 154, console, engine cover, or other portion of the vehicle 150. The horizontal section 112a is intermediate between the first section 110a and the second section 110b. In at least some embodiments, the horizontal section 112a has a length of at least 0.07, 0.1, 0.15, or 0.2 meters. The rail 102 can include one or more additional horizontal sections (e.g., sections 112b, 112c in FIG. 1). In at least some embodiments, the rail 102 can include one or more sections that are not solely vertical or horizontal.

In at least some embodiments, the rail 102 is configured to be attached or anchored to the floor 152, or other suitable portion, of the vehicle 150. In at least some embodiments, the rail 102 includes a first end 108a and a second end 108b each coupleable, or coupled, to the floor 152 of the vehicle 150 using the first attachment arrangement 104a and second attachment arrangement 104b, respectively. In at least some embodiments, the rail 102 is also coupled to the dashboard 154, console, or engine cover (or other portion) of the vehicle 150 intermediate the first and second ends 108a, 108b using at least one intermediate attachment arrangement 106.

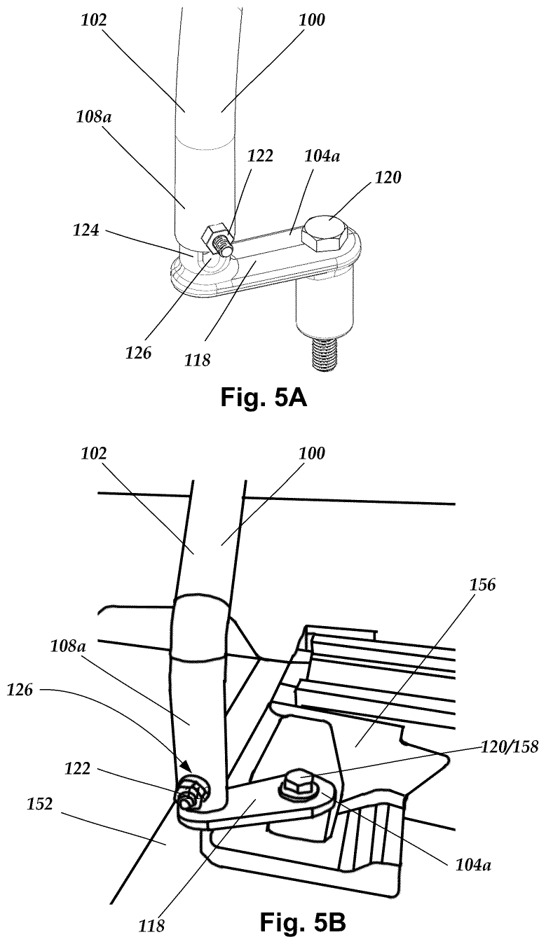

In at least some embodiments, the first attachment arrangement 104a couples the first end 108a of the rail 102 to the floor 152 of the vehicle 150 and the second attachment arrangement 104b couples the second end 108b of the rail to the floor of the vehicle. FIGS. 5A and 5B illustrate one embodiment of the first attachment arrangement 104a couples the first end 108a of the rail 102 to the floor 152 of the vehicle. In at least some embodiments, the first attachment arrangement 104a, the second attachment arrangement 104b, or both include at least one bracket 118 for attachment to the floor 152 of the vehicle 150. In at least some embodiments, the first attachment arrangement 104a, the second attachment arrangement 104b, or both include a bracket fastener 120, such as a bolt, screw, or the like to attach the bracket 118 to the floor 152 (or other portion) of the vehicle 150. In at least some embodiments, the first attachment arrangement 104a, the second attachment arrangement 104b, or both can be attached to a floor track 156 or a seat bolt 158 located on the floor 152 of the vehicle 150 and used for attachment and movement of a vehicle seat. In at least some embodiments, the first attachment arrangement 104a, the second attachment arrangement 104b, or both are attached to the floor track 156 using an existing seat bolt 158 or track bolt of the vehicle 150. Any other suitable hardware or methods can be used to attach the first and second attachment arrangements 104a, 104b to the floor 152 of the vehicle 150 and to the rail 102. In at least some embodiments, the first end 108a and second end 108b are coupled to the floor 152 of the vehicle 154 on opposite sides of the center console 159 (FIG. 4) of the vehicle, which separates the two seating areas of the vehicle. In at least some embodiments, the first end 108a is coupled to the vehicle using a floor track 156 (or using a track bolt) associated with one seat of the vehicle and the second end 108b is coupled to the vehicle using a floor track 156 (or using a track bolt) associated with a different seat of the vehicle. In at least some embodiments, the first end 108a is coupled to the vehicle using the seat bolt 158 of one seat of the vehicle and the second end 108b is coupled to the vehicle using the seat bolt 158 of a different seat of the vehicle.

In at least some embodiments, the first attachment arrangement 104a and the second attachment arrangement 104b are attached to the corresponding first end 108a or second end 108b using an attachment fastener 122, such one or more of a bolt, bolt/nut, screw, pin, clip, clamp, adhesive, or any other suitable fastener or any combination thereof. In at least some embodiments the first attachment arrangement 104a, the second attachment arrangement 104b, or both include an end attachment piece 124 extending from the bracket 118. The end attachment post 124 is arranged to fit inside (or over) the corresponding first end 108a or second end 108a for coupling the first attachment arrangement 104a and the second attachment arrangement 104b to the corresponding first end 108a or second end 108b. In at least some embodiments, the first end 108a, second end 108b, and the end attachment post 124 of each of the first attachment arrangement 104a and the second attachment arrangement 104b include holes 126 for receiving the fastener 122 therethrough.

Returning to FIGS. 1 to 4, in at least some embodiments, at least one intermediate attachment arrangement 106 couples the horizontal section 112a of the rail 102 to the dashboard 154 of the vehicle 150. It will be understood that at least one intermediate attachment arrangement 106 can be used to attach any other suitable section of the rail 102 to the dashboard 154, console, engine cover, or any other part of the vehicle instead of, or in addition to, the horizontal section 112a.

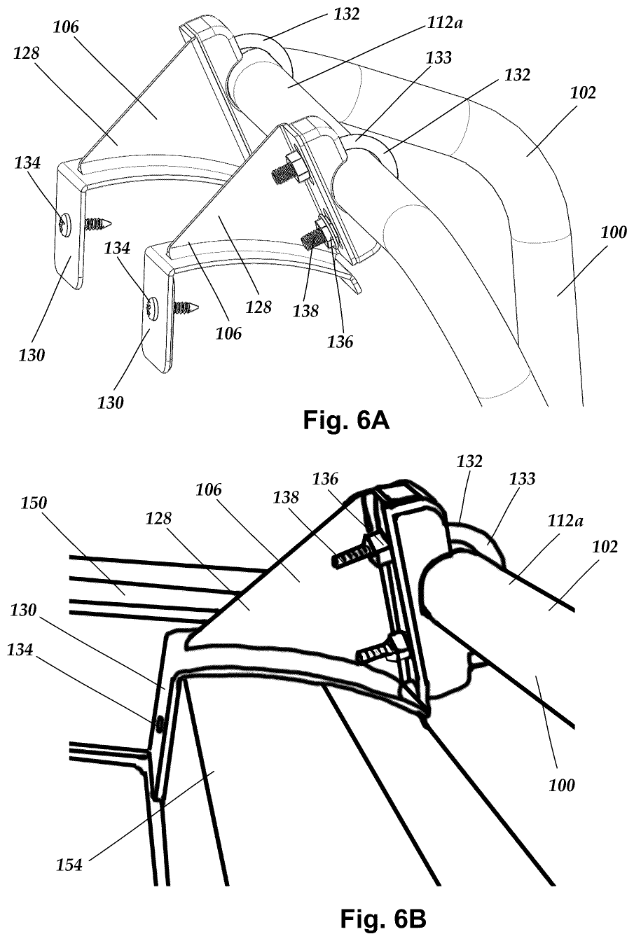

FIGS. 6A and 6B illustrate one embodiment of one or two intermediate attachment arrangements 106 attached to the rail 102. Each of the attachment arrangements 106 includes a body 128, a vehicle attachment bracket 130, and a rail attachment member 132. In at least some embodiments, the vehicle attachment bracket 130 is attached to the dashboard 154 or other part of the vehicle using a fastener 134, such as a screw, bolt, adhesive, or the like or any combination thereof, as illustrated in FIG. 6B. In at least some embodiments, the vehicle attachment bracket 130 is part of the body 128, as illustrated in FIG. 6A. In other embodiments, the vehicle attachment bracket 130 is attached to the body 128 using any suitable attachment method or hardware.

In at least some embodiments, the rail attachment member 132 extends around at least a portion of the rail 102 and is coupled to the body 128 of the intermediate attachment arrangement 106. In the illustrated embodiment of FIGS. 6A and 6B, the attachment member 132 includes a U-shaped shank 133 that is coupled to the body 128 using nuts 136 screwed onto threaded ends 138 of the U-shaped shank. Any other suitable hardware can be used for the rail attachment member 132 including, but not limited to, clamps, clips, adhesive, bolts, screws, other fasteners, brackets, or the like or any combination thereof. In the illustrated embodiments of FIGS. 6A and 6B, there are two intermediate attachment arrangements 106 but it will be understood that any number of intermediate attachment arrangements can be used including, but not limited to, one, two, three, four, five, six, seven, eight, nine, ten, twelve, or more intermediate attachment arrangements.

The first attachment arrangement 104a, second attachment arrangement 104b, and intermediate attachment arrangements 106 of FIGS. 5A to 6B are examples. It will be understood that any other suitable attachment arrangements or methods can be used to attach the rail 102 to the vehicle 150.

One or more mounts 140 can be attached to the rail 102. At least one mount 140 can be part of the mounting system 100. At least one mount 140 can be a separate component that is subsequently used with the mounting system. There can be any combination of these two types of mounts.

In at least some embodiments, at least one mount 140 (or even all of the mounts) are removably attachable to the rail 102 of the mounting system. In at least some embodiments, at least one mount 140 is permanently attached to the rail 102 of the mounting system. There can be any combination of mounts 140 removably attachable to the rail 102 and mounts permanently attached to the rail.

In at least some embodiments, at least one mount 140 is permanently attached to the device or object 180 that is to be mounted on the mounting system 100. In at least some embodiments, at least one mount 140 is removably attachable to the device or object 180 that is to be mounted on the mounting system 100. Any combination of these two types of mounts can be used.

Non-limiting examples of mounts 140 include mounting brackets, C-clamps, clip clamps, spring clamps, hose clamps, ratcheting clamps, tube clamps, ball mounts, mounting arms, bolts, screws, adhesive, or the like or any combination thereof. Non-limiting examples of mounts can be found at U.S. Pat. Nos. 5,845,885; 6,561,476; 7,320,50; 7,997,554; 8,454,178; 8,505,861; 9,831,904; RE42,060; RE42,581; and RE43,806, all of which are incorporated herein by reference in their entireties.

In at least some embodiments, one or more of the mounts 140 are arranged for at least one of (or all of) rotating, swiveling, pivoting, or tilting the device or object 180 relative to the rail 102, as illustrated, for example, by comparing device 180a and keyboard 180b in FIGS. 2 and 3. In at least some embodiments, one or more of the rotating, swiveling, pivoting, or tilting is independent of some or all of the other ones of these actions.

The above specification provides a description of the manufacture and use of the invention. Since many embodiments of the invention can be made without departing from the spirit and scope of the invention, the invention also resides in the claims hereinafter appended.

What is claimed as new and desired to be protected by Letters Patent of the United States is:

1. A mounting system for mounting devices or objects within a vehicle, the mounting system comprising:
a rail having a first end configured for coupling to a floor of the vehicle and a second end, opposite the first end, configured for coupling to the floor of the vehicle, the rail comprising a first section extending upward from the first end away from the floor of the vehicle when the rail is coupled to the floor of the vehicle, a second section extending upward from the second end away from the floor of the vehicle when the rail is coupled to the floor of the vehicle, and a horizontal section intermediate between the first section to the second section and having a horizontal length of at least 0.07 meters, wherein the rail is configured for attachment of one or more mounts to the rail at multiple positions along the rail;
a first attachment arrangement configured for attachment to the first end of the rail and for attachment to the floor of the vehicle;
a second attachment arrangement physically separate from the first attachment arrangement and configured for attachment to the second end of the rail and for attachment to the floor of the vehicle; and
an intermediate attachment arrangement configured for coupling the horizontal section of the rail to a dashboard, console, or engine cover of the vehicle.

2. The mounting system of claim 1, wherein the horizontal section has a horizontal length of at least 0.1 meters.

3. The mounting system of claim 1, wherein the rail comprises at least one additional upward-extending section.

4. The mounting system of claim 1, wherein the rail comprises at least one additional horizontal section.

5. The mounting system of claim 1, wherein the rail comprises at least six bends.

6. The mounting system of claim 1, wherein the rail comprises tubing.

7. The mounting system of claim 1, wherein the rail is made of a plastic material.

8. The mounting system of claim 1, wherein each of the first attachment arrangement and the second attachment arrangement comprises a bracket.

9. The mounting system of claim 1, wherein each of the first attachment arrangement and the second attachment arrangement is configured for coupling to a floor track or seat bolt of the vehicle using a fastener of the floor track.

10. The mounting system of claim 1, further comprising a mount attached or attachable to the rail.

11. The mounting system of claim 10, wherein the mount is configured for coupling to a device or object.

12. The mounting system of claim 11, wherein the mount is configured for at least one of rotating, tilting, pivoting, or swiveling the coupled device or object.

13. A method for using the mounting system of claim 1, the method comprising:
providing the mounting system in the vehicle; and
attaching a mount to the rail of the mounting system.

14. The method of claim 13, further comprising attaching a device or object to the mount.

15. The method of claim 14, further comprising pivoting, rotating, tilting, or swiveling the device or object attached to the mount.

16. The method of claim 13, wherein providing the mounting system comprises attaching the first attachment arrangement, the second attachment arrangement, and the intermediate attachment arrangement to the vehicle.

17. The method of claim 16, wherein the attaching comprises attaching each of the first attachment arrangement and the second attachment arrangement to a different floor track of the vehicle using a fastener of the floor track.

18. The method of claim 16, wherein the attaching comprising attaching the intermediate attachment arrangement to the rail and to a dashboard, console, or engine cover of the vehicle.

19. A method for making the mounting system of claim 1, the method comprising:
providing tubing; and
bending the tubing to form the rail with a plurality of bends.

20. The method of claim 19, further comprising scanning the vehicle or another vehicle of a same type with a three-dimensional scanner to obtain a shape of components within the vehicle, wherein the bending comprises bending the tubing using the scan of the vehicle to produce a shape of the rail.
